(19) United States
(12) Patent Application Publication
(10) Pub. No.: US 2002/0046263 A1
(43) Pub. Date: Apr. 18, 2002

(54) Method of configuring an automation module on a TCP/IP network

(76) Inventors: Jacques Camerini, Grasse (FR); Marc Leconte, Winchester, MA (US); Dennis J. W. Dube, Pelham, NH (US)

Correspondence Address: PARKHURST & WENDEL, L.L.P., Suite 210, 1421 Prince Street, Alexandria, VA, 22314-2805, US

(21) Appl. No.: 09/973,068

(22) Filed: Oct. 10, 2001

(30) Foreign Application Priority Data
Oct. 12, 2000 (FR) 00 13 191

(51) Int. Cl. G06F 15/16; G06F 15/177

(52) U.S. Cl. 709/219; 709/220; 709/245

(57) ABSTRACT

This invention relates to a method of configuring an automation module (10) on a TCP/IP network (5) comprising an assignment step (A) to assign a application name (40) that is unique on the TCP/IP network, memorized in the storage means (15) of the automation module, an addressing step (B) in which the automation module sends a request address query (17) containing its application name and conform with the DHCP protocol to a DHCP server (23), a configuration step (C) in which the automation module sends a read configuration query (18) to an FTP/TFTP server (24, 34) conform with the FTP or TFTP protocol The DHCP server and the FTP/TFTP server are installed in one or several items of automation equipment (20, 30) connected to the TCP/IP network. The invention also relates to an automation assembly capable of using such a configuration method.

This invention relates to a method for quickly configuring an automation module connected to a network conform with the TCP/IP protocol, particularly after replacement of a defective module. It also relates to an automation assembly comprising at least one automation equipment capable of using such a method. This invention may be applied to any automation assembly belonging to the domain of industrial process automation, building automation or to the domain of instrumentation/control automation for electrical distribution networks.

The term “automation module” in the following will denote any equipment provided with a processing unit and a communication interface with a TCP/IP network and used in an automation assembly, for example like an inputs/outputs module, a speed controller, a regulation device, a man/machine dialog terminal, a programmable logic controller or any specific module of a programmable logic controller or a numerical control. The term “automation equipment” as used in the following will denote a programmable logic controller, a numerical control, a computer based instrumentation/control station or any equipment provided with a processing unit and a communication interface with a TCP/IP network that can contain and execute an application program in an automation assembly.

Simplification of the operation to replace an automation module is an overriding consideration in an automation assembly. It is essential that this operation can be done quickly and easily by maintenance personnel who are not necessarily trained in computer network technologies, to minimize disturbance to the process managed by this automation assembly. Field buses normally encountered in the automation field frequently offer this type of possibility.

However, networks or sub-networks conform with the TCP/IP protocol, called TCP/IP networks in the rest of this description, are being more and more frequently used in the automation field. This type of network, that can include one or several TCP/IP sub-networks, is frequently associated with an Ethernet link layer. When replacing an automation module connected to this type of TCP/IP network, it is usually necessary to assign a unique MAC (Medium Access Control) address, and an IP (Internet Protocol) address to the new automation module. Furthermore, some automation modules have application parameters or configuration data that have to be reloaded in the new module to achieve satisfactory operation. Finally, if a BOOTP (Boot Protocol) type protocol is used capable of retrieving an IP address from a MAC address, the BOOTP server configuration data will have to be updated if the module is changed since all MAC addresses are unique.

Therefore these operations are difficult for maintenance personnel and can introduce errors that are penalizing for the process. It would then be desirable to be able to offer services to simplify maintenance operations for automation modules connected to this type of TCP/IP network.

Therefore, the purpose of the invention is to propose a method to overcome the dependence on MAC addressing for a new automation module connected to a TCP/IP network. The invention must also make it possible to automatically assign an IP address to this new module and to automatically reload a data file into the module, possibly also containing parameters and programs. The proposed solution for fast and easy installation into a module and into automation equipment should be based on standard protocols in the Internet world such as the DHCP (Dynamic Host Configured Protocol) protocol described in document RFC 2131 and FTP (File Transfer protocol) or TFTP (Trivial File Transfer Protocol) protocols described in documents RFC 959 and RPC 1350. The DHCP protocol is used to allocate an IP address and transmit configuration data such as the address of a data server. The FTP and TFTP protocols are used to make file transfers in a TCP/IP network.

To achieve this, the invention describes a method of configuring an automation module on the TCP/IP network or on the TCP/IP sub-network, to which at least one piece of automation equipment is also connected. The configuration method comprises the following steps in sequence: a preliminary step to assign a single application name on the TCP/IP network for the automation module; an addressing step in which the automation module sends a request address query on the TCP/IP network containing the application name of the automation module and conform with the DHCP protocol, to a DHCP server; a configuration step in which the automation module sends a read configuration query to the FTP/TFTP server conform with the FTP or TFTP protocol, on the TCP/IP network. During the addressing step, the automation module receives a response to the request address query from the DHCP query server, containing an IP address and the location of a data file specific to the automation module, making it possible to go on to the configuration step. During the configuration step, the automation module receives a response to the read configuration query from the FTP/TFTP server, containing the automation module data file that can then change to an operational state.

The invention also describes an automation assembly capable of using such a configuration method. This assembly comprises at least an automation module connected to a TCP/IP network provided with a processing unit connected to storage means and to a network communication interface. The automation module is capable of memorizing a specific application name in its storage means and its processing unit can execute a DHCP client and a FTP/TFTP agent. A first item of automation equipment is connected to the TCP/IP network and provided with a processing unit connected to storage means and to a network communication interface, and this processing unit can execute a DHCP server and a configuration table can be memorized in its storage means, associating the application name with a least one DHCP client with an IP address and with a data file location. Furthermore, a FTP/TFTP server can be executed in the processing unit of the first automation equipment, in a processing unit of a second automation equipment connected to the TCP/IP network or in a file server dedicated to this purpose.

Other characteristics and advantages will be described in the detailed description given below with reference to an embodiment given as an example and represented by the attached drawings in which:

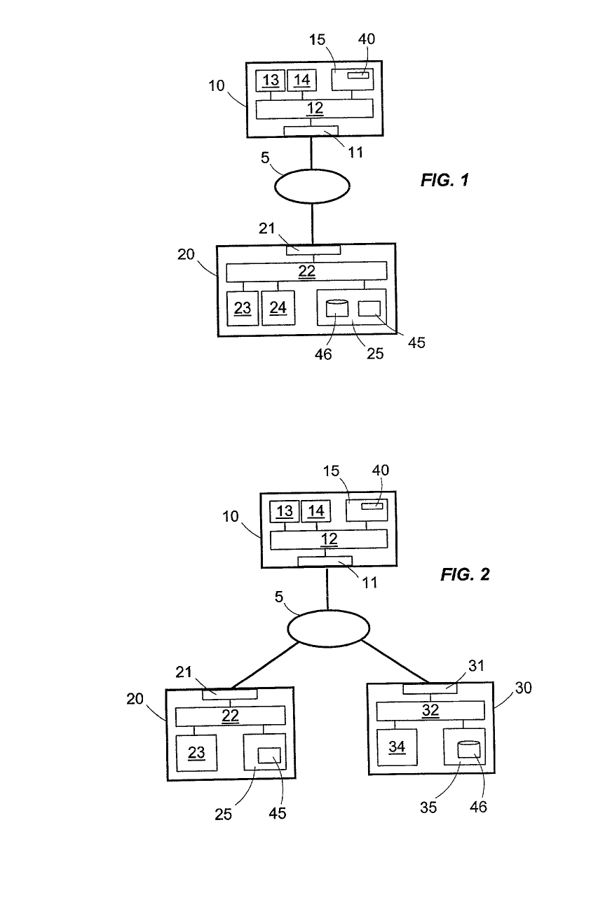

FIG. 1 shows an architecture in which an automation module is connected through a TCP/IP network to automation equipment in accordance with the invention,

FIG. 2 shows a variant of FIG. 1 with two items of automation equipment,

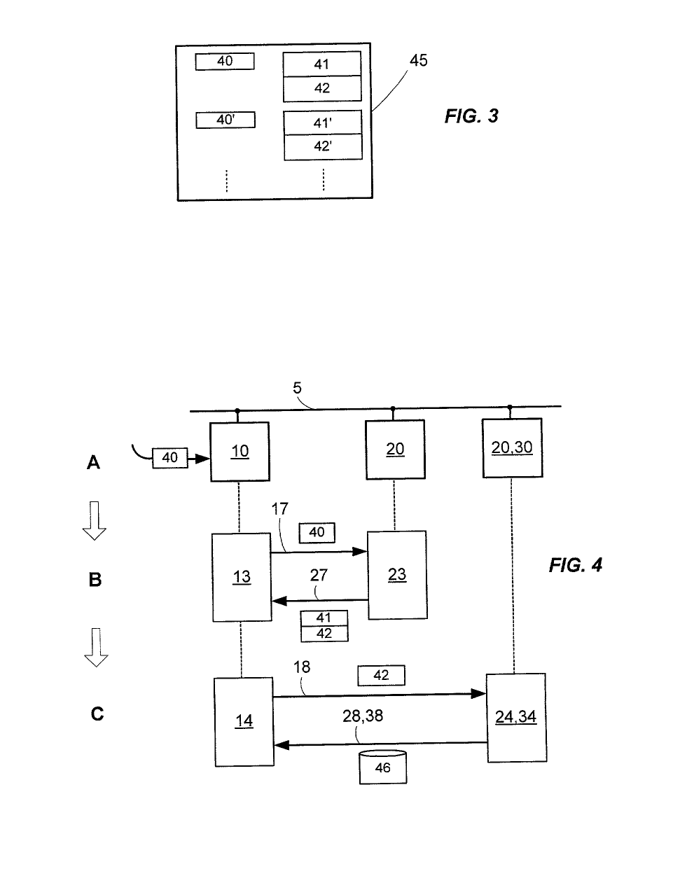

FIG. 3 shows details of a configuration table contained in a DHCP server,

FIG. 4 shows a representation of steps in the method of configuring an automation module.

In the rest of this document, the term “IP addressing” will be considered to mean the set consisting of an IP address, a sub-network mask and a gateway address sufficient to completely define the address of the automation module on a TCP/IP network. Similarly, the term “location” of the data file of an automation module includes the set composed of the IP address of the FTP/TFTP server containing the data file considered, the access path to the data file in the FTP/TFTP server, and possibly also the connection key(s) to the FTP/TFTP server so that this data file can be accessed (for example user name and password).

The automation assembly shown in FIG. 1 includes an automation module 10 comprising a processing unit 12 connected to a network interface 11 and information storage means 15. The module 10 is connected to the TCP/IP network 5 through the network interface 11. It is capable of executing a DHCP client 13 and a FTP or TFTP agent called an FTP/TFTP agent 14, in its processing unit 12. The final user is unaffected by the choice between the FTP protocol and the TFTP protocol, since the functions used in the invention are essentially read file queries (“READ/GET”) and write file queries (“WRITE/PUT”). The only difference is that the TFTP agent is more compact than the FTP agent and can therefore be more easily installed in the memory of a small automation module. The automation module 10 can memorize an application name 40 specific to the automation module 10, in its storage means 16.

The automation assembly also comprises at least one item of automation equipment 20 comprising a processing unit 22 connected to a network interface 21 and information storage means 25. The equipment 20 is connected to the TCP/IP network 5 through its network interface 21. It is capable of executing a DHCP server 23 or an FTP or TFTP server called an FTP/TFTP server 24, in its processing unit 22. The automation equipment 20 memorizes a data file 46 with at least one FTP/TFTP agent 14 belonging to an automation module 10, in its storage means 25. The automation equipment 20 also memorizes a configuration table 45 associating the application name 40 with at least one DHCP client 13 of an automation module 10 with an IP addressing 41 and with a location 42 of a data file specific to the automation module 10, in its storage means 25. In the example shown in FIG. 3, a configuration table 45 comprises two application names 40, 40′ at its input, corresponding to two IP addressing 41, 41′, and two locations 42, 42′ at its output.

In the variant shown in FIG. 2, the DHCP servers and the FTP/TFTP servers have been separated such that the automation assembly comprises a first and second automation equipment 20, 30 respectively, each comprising a processing unit 22, 32 respectively connected to a network interface 21, 31 and to information storage means 25, 35. The first automation equipment 20 is capable of executing a DHCP server 23 in its processing unit 22, and the second automation equipment 30 is capable of executing an FTP/TFTP server 34 in its processing unit 32. The storage means 25 of the first automation equipment 20 memorise a configuration table 41 and the storage means 35 of the second automation equipment 30 memorise a data file 46.

The configuration method proposed comprises the following steps in sequence, with reference to FIG. 4:

A preliminary step A in which an application name is assigned. The purpose of this step is to assign to the automation module 10 an application name 40 that must be unique in the TCP/IP network or sub-network 5 accessible to the DHCP server 23. This application name 40 is composed of an ASCII character string. The assignment step A may indifferently be made before the module 10 is connected to the TCP/IP network 5.

Depending on the capacities of the automation module 10, it would be possible to use many assignment means to assign an application name 40 to a module 10; local assignment using a Man-Machine interface, assignment by local communication (serial link, etc.) or remote communication (web page), assignment by mechanical means (encoder wheels, switches, etc.). A combination of these different assignment methods is also possible. Furthermore in some modules the application name 40 can also be formed by concatenation of characters predefined by the manufacturer to characterize a type of family of modules, in combination with a customisation number assigned by one of the assignment methods mentioned. Once determined, the processing unit 12 of the automation module 10 is capable of memorizing the application name 40 in the storage means 15. The existence of an application name 40 memorized in the automation module 10 controls whether or not the program can go on to the next step. When a defective automation module is replaced by a new module, the application name used for the defective module will be reassigned to this new module so that it can retrieve the data file for the defective module.

An addressing step B in which the automation module 10 must be connected to the TCP/IP network 5 accessible to a server DHCP 23. The DHCP client 13 for the automation module 10 can then send a request address query 17 conform with the DHCP protocol to the DHCP server 23 installed in the automation equipment 20. This DHCP request address query 17 contains an optional DHCP field (client identifier code 61) containing the application name 40 that was memorized in the storage means 15 of the automation module 10, as a parameter.

When the DHCP request address query 17 is received, the DHCP server 23 searches in the configuration table 45 memorized in the storage means 25 of the automation equipment 20 for an IP addressing 41 and a location of the data file 42 corresponding to the received application name 40.

If the application name 40 is present in the configuration table 41, then the DHCP server 23 sends a response 27 to the request address query 17 conform with the DHCP protocol. This DHCP response 27 contains the IP addressing 41 as a parameter and the location of the corresponding data file 42 with the application name 40 of the module 10. If the application name 40 is not present in the configuration table 45, then the DHCP server 23 sends an error response following a defined procedure not described in detail in this document. The automation module 10 can go on to the next configuration step C after the response 27 has been received.

A configuration step C in which the FTP/TFTP client 14 of the automation module 10 can send a read configuration query 18 conform with the FTP/TFTP protocol to an FTP or TFTP server 24 or 34 installed in an automation equipment 20 or 30 respectively. This FTP/TFTP read configuration query 18 contains the location 42 of the data file received by the automation module 10 with the DHCP response 27, as a parameter. Due to this location 42, the FTP/TFTP server 24, 34 is capable of finding the data file 46 memorized in the storage means 25, 35 and returning an FTP/TFTP response 28, 38 to the read configuration query 18 containing the data file 46 specific to the automation module 10. If the FTP/TFTP server cannot access a correct data file corresponding to the received location 42, it returns an error message according to a defined procedure not described in detail in this document.

When the data file 46 is received by the FTP/TFTP client 14, the processing unit 12 in module 10 can make some checks (validity of file data, compatibility with the module present, etc.) before loading this data file into the storage means 15 of module 10. Once the data file has been loaded, the configuration method is completed and the automation module 10 goes into an operational state in which it is capable of operating normally.

The configuration method also includes the feature that, when an automation module is in the operational state, it is capable of making FTP/TFTP read (READ/GET) configuration queries 18 in order to check or reload all or some of its data file 46 memorized in the storage means of an FTP/TFTP server 24, 34, on its own initiative or following an event and/or periodically. Similarly, when an automation module is in the operational state, it is capable of making FTP/TFTP write (WRITE/PUT) configuration queries to update or backup all or some of its data file 46 memorized in the storage means of an FTP/TFTP server 24, 34, on its own initiative, on an event and/or periodically. An automation module can thus be replaced under good conditions since the data file 46 associated with an automation module and memorised in the FTP/TFTP server can be checked and updated regularly at the initiative of the module. Therefore, the file 46 can be reloaded into a new automation module in the case of a replacement, and the new version will always be up to date.

Any application name 40 of the automation module 10 must firstly be input by appropriate means into the configuration table 45 of a DHCP server 23 by associating an IP addressing 41 with the automation module. Once the configuration table has been updated, a module 10 can be replaced by another module with the same application name 40 using the method described in this document. When a new application name 40 is input into the configuration table 45, a corresponding empty data file 46 is also generated in the FTP/TFTP server 24. Similarly, if an application name 40 is removed from the configuration table 45, the corresponding data file 46 will be deleted in the FTP/TFTP server 24. Preferably, the data file 46 is named by associating the corresponding application name 40 with it; for example, the data file 46 can be called “application name.prm”. When a new application name 40 is input, the location 42 of the data file 46 in the FTP/TFTP server 24 must also be created in the configuration table 45.

The contents of the data file 46 depend on the type of module 10 and its application in the process. Nevertheless, it is preferable that the data file 46 should contain at least the data necessary such that a defective automation module can be replaced by another, transparently to the user. The data file 46 may indifferently contain:

communication parameters (HTTP user name, passwords, list of authorized IP addresses, etc.),

module identification parameters (type, serial number, version) in order to check that the new automation module 10 input to replace an old version is compatible with the old version,

application parameters containing current values of variables specific to the process managed by the automation module 10 (set values, measurements, etc.),

configuration data or data in the application program loaded and executed in the automation module 10.

Obviously, it would be possible to imagine other variants and improvements to detail and even to consider the use of equivalent means, without going outside the scope of the invention.

1. Configuration method for an automation module (10) on a TCP/IP network (5) to which at least one item of automation equipment (20) is also connected, characterized in that the configuration method comprises the following steps in sequence:
A preliminary step (a) in which an application name (40) is assigned, this application name being unique on the tcp/ip network (5) for the automation module (10):
An addressing step (B) in which the automation module (10) sends a request address query (17) on the TCP/IP network (5), containing the application name (40) of the automation module (10) and conform with the DHCP protocol.
A configuration step (C) in which the automation module (10) sends a read configuration query (18) conform with the FTP or TFTP protocol, on the TCP/IP network (5), to an FTP/TFTP server (24, 34).

2. Configuration method according to claim 1, characterized by the fact that the DHCP server (23) is installed in automation equipment (20) connected to the TCP/IP network (5).

3. Configuration method according to claim 1 or 2, characterized by the fact that the FTP/TFTP server (24, 34) is installed in automation equipment (20, 30) connected to the TCP/IP network (5).

4. Configuration method according to claim 1, characterized by the fact that during the addressing step (B), the automation module (10) receives a response (27) to the request address query (17) from the DHCP server (23), containing an IP addressing (41) and a location (42) of a data file (46) specific to the automation module (10), making it possible to go on to configuration step (C).

5. Configuration method according to claim 4, characterized by the fact that the read configuration query (18) uses the location (42) of the data file for the automation module (10).

6. Configuration method according to claim 5, characterized by the fact that during the configuration step (C), the automation module (10) receives a response (38) to the read configuration query (18) from the FTP/TFTP server (24, 34), containing the data file (46) for the automation module (10), such that the automation module can then change to an operational state.

7. Configuration method according to claim 6, characterized by the fact that the data file (46) of an automation module is identified using the application name (40) of the automation module (10).

8. Configuration method according to claim 6, characterized by the fact that when an automation module (10) is in the operational state, it can send a write configuration query on its own initiative to the FTP/TFTP server (24, 34) to update or save all or some of its data file (46).

9. Configuration method according to claim 6, characterized by the fact that when an automation module (10) is in the operational state, it can send a read configuration query on its own initiative to the FTP/TFTP server (24, 34) to check or reload all or some of its data file (46).

10. Automation assembly capable of implementing a method of configuring an automation module (10) according to any one of the previous claims, the automation assembly comprising at least one automation module (10) connected to a TCP/IP network (5) and equipped with a processing unit (12) which is connected to storage means (15) and to a network communication interface (11), characterized by the fact that the automation module (10) is capable of memorizing an application name (40) specific to the automation module (10) in its storage means (15), and can execute a DHCP client (13) and an FTP/TFTP agent (14) in its processing unit (12).

11. Automation assembly according to claim 10, comprising first automation equipment (20) that is connected to the TCP/IP network (5) and that is equipped with a processing unit (22) connected to storage means (25) and to a network communication interface (21) characterized by the fact that the first automation equipment (20) can execute a DHCP server (22) in its processing unit (22) and can memorize a configuration table (45) in its storage means (25), associating the application name (40) of at least one DHCP client (13) with an IP addressing (41) and a location (42) of a data file.

12. Automation assembly according to claim 11 comprising a second automation equipment (30) that is connected to the TCP/IP network (5) and that is provided with a processing unit (32) connected to storage means (35) and to a network communication interface (31), characterized by the fact that the second automation equipment (30) can execute an FTP/TFTP server (34) in its processing unit (32) and can memorize a data file (46) corresponding to at least one FTP/TFTP agent (14) in its storage means (35).

13. Automation assembly according to claim 11, characterized by the fact that the first automation equipment (20) can execute an FTP/TFTP server (24) in its processing unit (22) and can memorize a data file (46) corresponding to at least one FTP/TFTP agent (14) in its storage means (25).
